(19) United States
(12) Patent Application Publication
(10) Pub. No.: US 2025/0142589 A1
(43) Pub. Date: May 1, 2025

(54) METHODS AND APPARATUS FOR ENABLING SINGLE DOWNLINK CONTROL INFORMATION (DCI) SCHEDULING OF MULTIPLE CELLS

(71) Applicant: InterDigital Patent Holdings, Inc., Wilmington, DE (US)

(72) Inventors: Aata El Hamss, Laval (CA); Moon-il Lee, Melville, NY (US); Paul Marinier, Brossard (CA); Faris Alfarhan, Montreal (CA)

(21) Appl. No.: 18/835,822

(22) PCT Filed: Feb. 10, 2023
(86) PCT No.: PCT/US2023/012779

§ 371 Date: Aug. 5, 2024

Related U.S. Application Data
(60) Provisional application No. 63/309,100, filed on Feb. 11, 2022.
(60) Provisional application No. 63/327,452, filed on Apr. 5, 2022.
(60) Provisional application No. 63/410,435, filed on Sep. 27, 2022.

(51) Int. Cl. H04W 72/232; H04W 72/1273

(52) U.S. Cl. CPC H04W 72/232; H04W 72/1273

(57) ABSTRACT

The disclosure pertains to methods and apparatus for enabling single DCI scheduling of multiple cells. A method implemented in a wireless transmit/receive unit (WTRU), includes receiving, by the WTRU, a single downlink control information (DCI). The method additionally includes determining, by the WTRU, scheduling of multiple cells based on the single DCI. The method also includes performing wireless communications, by the WTRU, based on the determination.

### CROSS-REFERENCE TO RELATED APPLICATIONS

The present application claims the benefit of U.S. Provisional Patent Application No. 63/309,100 filed Feb. 11, 2022, U.S. Provisional Patent Application No. 63/327,452 filed Apr. 5, 2022, and U.S. Provisional Patent Application No. 63/410,435 filed Sep. 27, 2022, each of which is incorporated herein by reference.

### FIELD OF THE INVENTION

This disclosure pertains to methods and apparatus for enabling single DCI scheduling of multiple cells.

### BACKGROUND

This disclosure pertains to methods and apparatus for enabling single DCI scheduling of multiple cells. Supporting scheduling of multiple cells with a single DCI may have a potential of reducing overhead but at the same time may lead to a large size DCI if all bitfields are multiplied by the number of scheduled cells.

There is a need for designing a single DCI to schedule multiple cells while keeping a low overhead on the control channel.

### SUMMARY

Methods and apparatus for enabling single DCI scheduling of multiple cells are provided herein.

In an embodiment, a method, implemented in a wireless transmit/receive unit (WTRU) may comprise receiving configuration information including a plurality of identifiers, each identifier of the plurality of identifiers associated with one set of cells of a plurality of sets of cells. The method may further comprise receiving downlink control information, DCI, masked with a first identifier included in the received configuration information, wherein the first identifier is used to unmask the DCI during said reception of said DCI. The method may further comprise determining a set of cells associated with the DCI, the set of cells including at least a first cell and a second cell; and communicating, using information elements associated with the received DCI, via the set of cells including the at least first and second cells.

The information elements may indicate a first communication parameter associated with the first cell, and a second communication parameter associated with the second cell.

The received DCI may comprise a modulation and coding scheme (MCS) bitfield. The method may further comprise determining MCS value of the first communication parameter and the MCS value of the second communication parameter based on the MCS bitfield. The MCS bitfield may point to at least one MCS value of a MCS table of the WTRU.

The first communication parameter and the second communication parameter may respectively comprise a first modulation and coding scheme and a second modulation and coding scheme for communicating via the respective first cell and second cell.

The identifier of the plurality of identifiers may be used to scramble a cyclic redundancy check of the DCI.

The plurality of identifiers may be a plurality of radio network temporary identifiers, RNTIs.

The WTRU configuration of the association of each identifier of the plurality of identifiers with one set of cells of a plurality of sets of cells may be a semi-statically configuration. The WTRU may be semi-statically configured using radio resource control signaling.

In an embodiment, a method implemented in a wireless transmit/receive unit (WTRU), may comprise receiving, by the WTRU, a single downlink control information (DCI). The method may further comprise determining, by the WTRU, scheduling of multiple cells based on the single DCI; and performing wireless communications, by the WTRU, based on the determination.

Determining the scheduling may include determining the multiple cells based on a cell on which the WTRU received the single DCI. Determining the scheduling may include determining the multiple cells based on a radio network temporary identifier (RNTI) used to scramble a cyclic redundancy check (CRC) of the single DCI. Determining the scheduling may include determining the multiple cells based on a format of the single DCI. Determining the scheduling may include determining the multiple cells based on a bitfield identifying one or more target cells. Determining the scheduling may include determining the multiple cells based on a DCI/media access control-control element (MAC) CE indicating scheduling information and one or more target cells. Determining the scheduling may include determining a number of scheduled cells using a counter downlink assignment index (DAI) in the single DCI and a total of (DAI) values in the single DCI.

A value of a difference between the counter DAI and the total of DAI values in the single DCI may indicate the number of scheduled cells.

Determining the scheduling may include determining to at least one of transmit or receive at least one of one or more channel state information-reference signal (CSI-RS) or one or more sounding reference signal (SRS) on one or more of the multiple cells based on at least one bit contained in the single DCI.

A number of blind decoding attempts for a single DCI scheduling multiple cells may depend on a number of targeted cells for that DCI.

The WTRU may assume a semi-static configuration for a certain transmission parameter if a bitfield does not exist in the single DCI.

The method may further comprise receiving, by the WTRU, a separate DCI that is separate from the single DCI; and determining, by the WTRU, power control parameters for the multiple cells based on the separate DCI, wherein performing the wireless communications is further based on the determined power control parameters.

The method may further comprise determining, by the WTRU, target cells based on the single DCI; and determining, by the WTRU, transmission parameters based on determined target cells, wherein the performing wireless communications includes exchanging information, by the WTRU, with the determined target cells using the determined transmission parameters.

The WTRU may be configured with a set of bitfields that is always present in the single DCI and another set of bitfields that is associated with target cells. The set of bitfields that is always present may not depend on the target cells. Multiple sets of bitfields may be configured and associated with the target cells.

The WTRU may determine that at least one set of the multiple sets of bitfields is present in the single DCI depending on the determined target cells.

### BRIEF DESCRIPTION OF THE DRAWINGS

A more detailed understanding may be had from the detailed description below, given by way of example in conjunction with the drawings appended hereto. Figures in such drawings, like the detailed description, are exemplary. As such, the Figures and the detailed description are not to be considered limiting, and other equally effective examples are possible and likely. Furthermore, like reference numerals (“ref.”) in the Figures (“FIGS.”) indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2A is a flow diagram illustrating a method for enabling single downlink control information (DCI) scheduling of multiple cells;

FIG. 2B is a flow diagram illustrating a method for enabling separate DCI power control of the multiple cells;

FIG. 3 is a graphical illustration depicting single DCI scheduling of multiple cells; and

FIG. 4 is a flow diagram illustrating WTRU determination of transmission parameters based on determined target cells.

FIG. 5 is a flow diagram illustrating a method, implemented in a WTRU, for enabling single downlink control information scheduling of multiple cells.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components, and circuits have not been described in detail, so as not to obscure the following description. Further, embodiments and examples not specifically described herein may be practiced in lieu of, or in combination with, the embodiments and other examples described, disclosed, or otherwise provided explicitly, implicitly and/or inherently (collectively “provided”) herein.

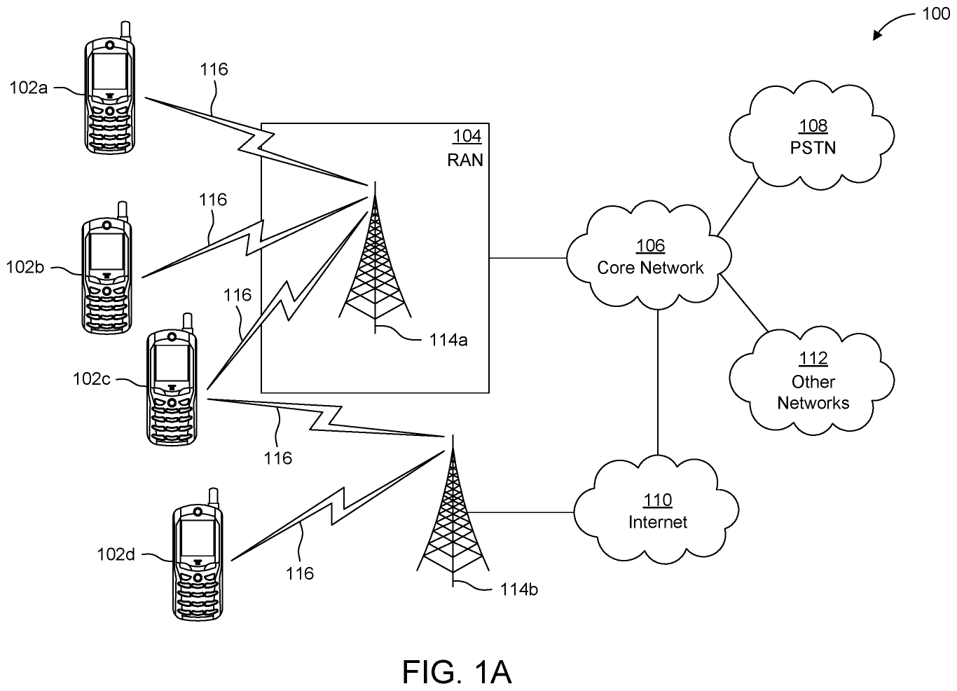

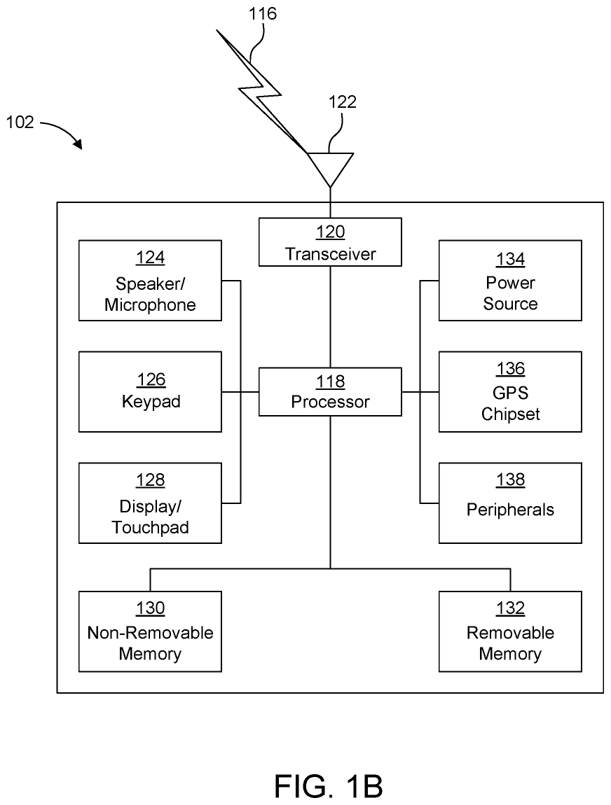

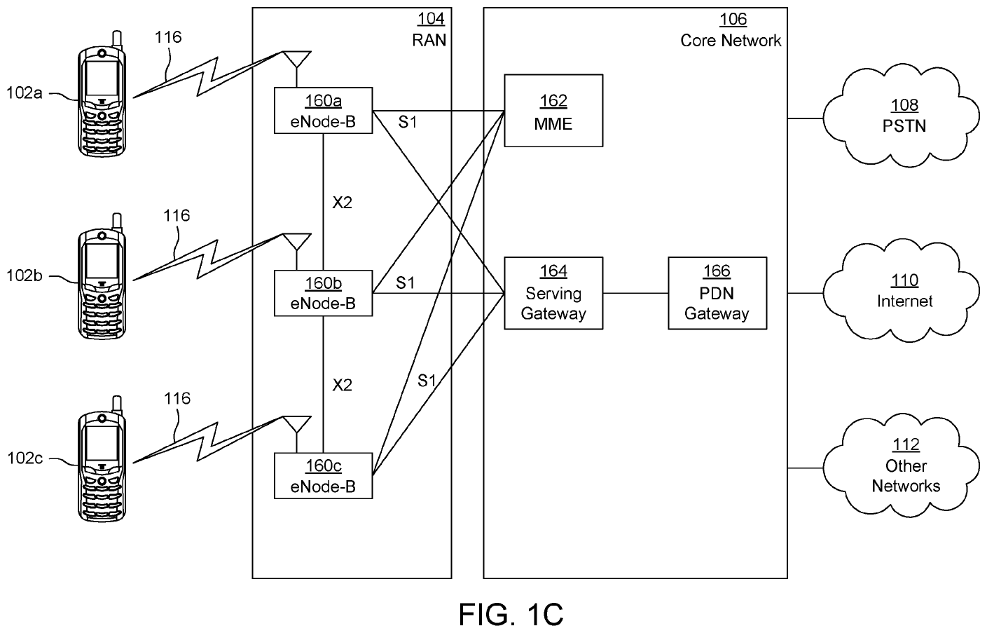

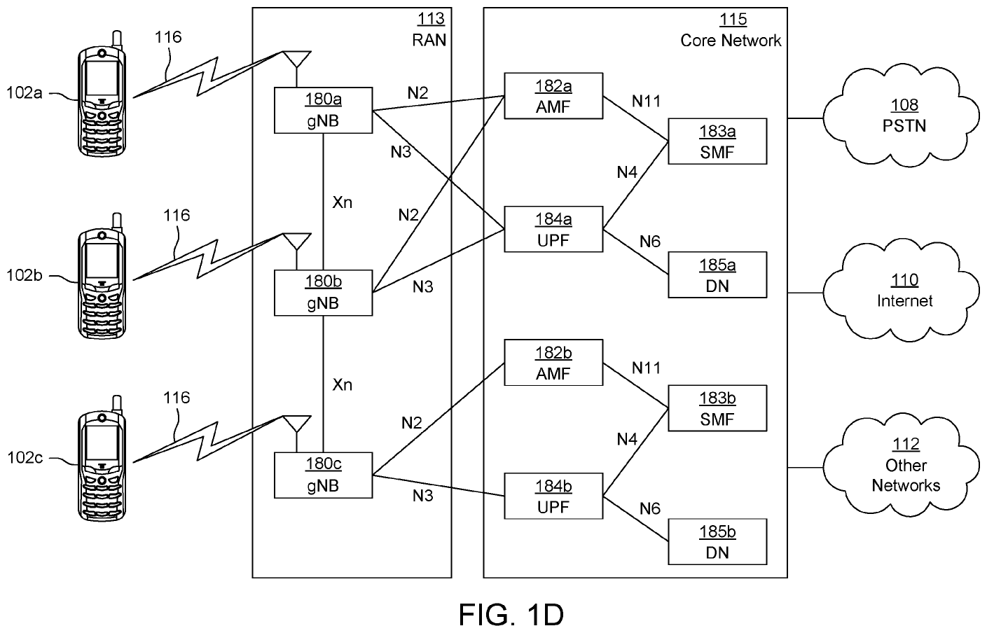

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUS 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac, 802.11af supports 5 MHZ, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 180b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the uplink (UL) and/or downlink (DL), support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 182a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In the description below, methods and apparatus for enabling single DCI scheduling of multiple cells are presented. For the case of multiple narrow carriers corresponding to fragmented spectrum, it is inefficient to use multiple DCI transmitted in each one of the narrow carriers. To enhance the control channel overhead for the case of fragmented spectrum, NR Rel-18 will support a single DCI scheduling multiple cells. Different cells may have different configuration and features associated therewith. For example, there exists the scenario of multiple cells with some operating in licensed operation and others operating in unlicensed operation. For unlicensed operation, channel access type is indicated using DCI for uplink transmission whereas, for licensed operation, no channel access type information is needed. Scheduling multiple cells with different features by using the same DCI will add high overhead in the DCI. This disclosure details techniques for designing a DCI to schedule multiple cells while keeping a low overhead on the scheduling DCI. The WTRU may be configured with one DCI format that can schedule one or more cells. The WTRU may first determine a subset of scheduled cells and then interpret the DCI accordingly. Another technique described herein involves a single DCI triggering the WTRU to transmit/receive configured grants/DL SPS on a first subset of cells and dynamic grants on a second subset of cells.

For NR low FR1 frequency bands (below 7.125 GHZ), the available spectrum blocks tend to be more fragmented and scattered with narrower bandwidth. In the existing wireless systems, a single downlink control channel is used to schedule a transmission (PUSCH) or reception (PDSCH) in a single carrier. For the case of multiple narrow carriers corresponding to fragmented spectrum, it is inefficient to use multiple DCI transmitted in each one of the narrow carriers (i.e., inefficient control channel overhead). To ensure that the fragmented spectrum is utilized in a spectrally efficient way, it was proposed to enhance the control channel overhead for this case. A work item was agreed upon in 3GPP to specify one or more solutions for multi-cell PUSCH/PDSCH scheduling (one PDSCH/PUSCH per cell) with a single DCI.

On one hand, supporting scheduling multiple cells with a single DCI has the potential of reducing the overhead by using a single DCI for more than one cell (instead of using a DCI per cell). On the other hand, the single DCI scheduling of multiple cells can result in having a very large size DCI if all the bitfields are multiplied by the number of scheduled cells. Increasing the DCI size by adding all the possible bitfields for every scheduled cell will go against the objective of reducing the control channel overhead. It may even require more control channel overhead to reach a certain reliability. In fact, large DCI size may require a high number of control channel elements (CCEs) and a higher aggregation level to meet a certain reliability requirement. Issues arising in this context include how to design a single DCI to schedule multiple cells while keeping a low overhead on the control channel.

Different cells may have different configuration and features associated therewith. For example, different bandwidth requires different size of frequency domain resource allocation (FDRA) bitfield in the scheduling DCI. Another example is the scenario of multiple cells with some operating in licensed and others operating in unlicensed operation. For unlicensed operation, channel access type is indicated using DCI for uplink transmission whereas for licensed operation, no channel access type information is needed. Scheduling multiple cells with different configurations by using the same DCI may add high overhead in the DCI if the WTRU does not determine which cells are to be scheduled prior to the DCI reception.

Techniques for designing a DCI to schedule multiple cells while keeping a low overhead on the scheduling DCI is described below.

The WTRU may be configured with multiple cells/carriers for data transmission and/or reception (carrier aggregation). The WTRU may be configured to receive a single DCI to schedule multiple cells with PDSCH or PUSCH transmissions. The group of cells that will be scheduled using a single DCI is referred to herein as the “target cells”. Determining the target cells includes of determining the number of cells as well as the cell ID of each cell belonging to the target cells.

In the following disclosure, dynamic scheduling refers to scheduling a PDSCH or a PUSCH. A configured grant refers to an uplink configured grant or downlink semi-persistent scheduling.

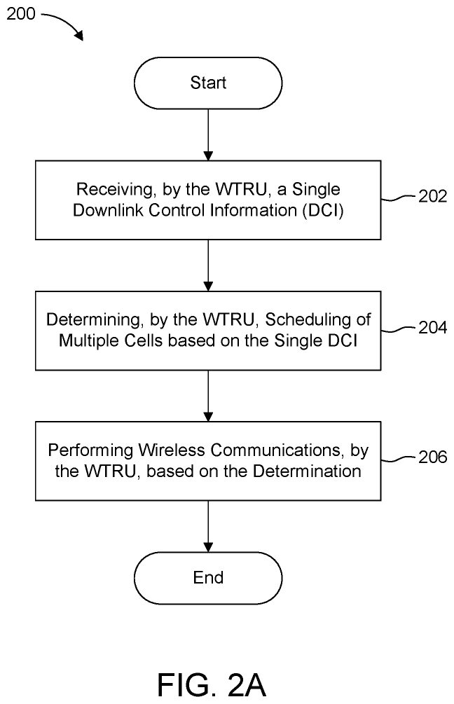

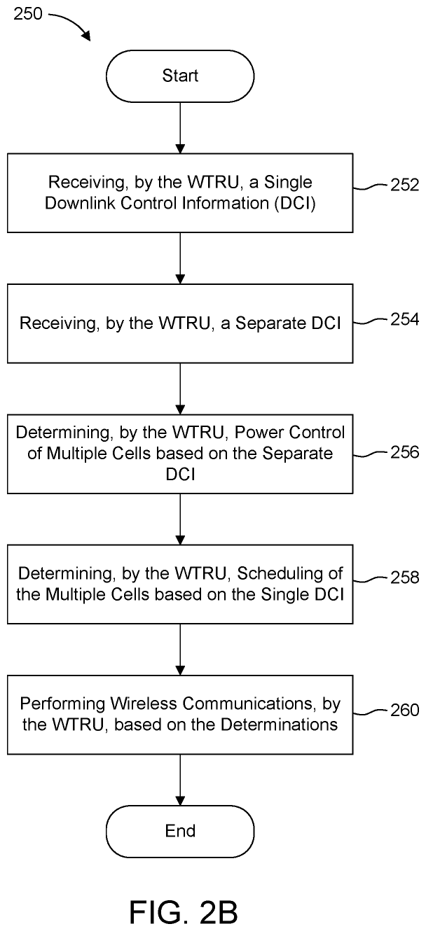

Referring to FIG. 2A, an exemplary method 200 implemented in a wireless transmit/receive unit (WTRU), begins at step 202. Step 202 may include receiving, by the WTRU, a single downlink control information (DCI). Processing may proceed from step 202 to step 204.

Step 204 may include determining, by the WTRU, scheduling of multiple cells based on the single DCI. For example, determining the scheduling at step 204 may include determining the multiple cells based on a cell on which the WTRU received the single DCI. Alternatively, determining the scheduling at step 204 may include determining the multiple cells based on a Radio Network Temporary Identifier (RNTI) used to scramble a cyclic redundancy check (CRC) of the single DCI. In another alternative, determining the scheduling at step 204 may include determining the multiple cells based on a format of the single DCI. In yet another alternative, determining the scheduling at step 204 may include determining the multiple cells based on a bitfield identifying one or more target cells. In a further alternative, determining the scheduling at step 204 may include determining the multiple cells based on a DCI/media access control-control element (MAC-CE) indicating scheduling information and one or more target cells. Advantageously, when performing the wireless communications, a number of blind decoding attempts for a single DCI scheduling multiple cells may depend on a number of targeted cells for that DCI. The WTRU may assume a semi-static configuration for a certain transmission parameter if a bitfield does not exist in the single DCI. It should be understood that the determining at step 204 may include combinations of the above. Processing may proceed from step 204 to step 206.

Step 206 may include performing wireless communications, by the WTRU, based on the determination. For example, the WTRU may, at step 206, determine transmission parameters of the scheduled transmissions on the determined target cells, and perform transmissions on the target cells according to the determined transmission parameters. Alternatively, the WTRU may perform configured grants transmission at step 206. In another alternative, the WTRU may perform transmission of both configured and dynamic grants at step 206. It should be understood that the performance of wireless communications at step 204 may include combinations of the above. After step 206, processing may end. Alternatively, processing may return from step 206 to an earlier point in the process, such as step 202 or step 204.

Referring to FIG. 2B, an exemplary method 250 implemented in a wireless transmit/receive unit (WTRU), begins at step 252. Step 252 may include receiving, by the WTRU, a single downlink control information (DCI). Processing may proceed from step 252 to step 254.

Step 254 may include receiving, by the WTRU, a separate DCI that is separate from the single DCI. Processing may proceed from step 254 to step 256.

Step 256 may include determining, by the WTRU, power control parameters for the multiple cells based on the separate DCI. For example, the separate DCI may indicate a transmit power control TCP command for one or more of the multiple cells and/or an open loop power control (OLPC) parameter set for one or more of the multiple cells. Processing may proceed from step 256 to step 258.

Step 258 may include determining, by the WTRU, scheduling of multiple cells based on the single DCI in a same or similar manner as described above with reference to step 206 of FIG. 2A. Additionally step 258 may include determining whether a cell is to be scheduled or not (using the single DCI) based on the indicated power control parameters for that cell. For example, a zero transmit power indicated for a cell can be interpreted by the WTRU as no transmission is scheduled for that cell. The WTRU may then decode the single DCI scheduling multiple cells accordingly. Processing may proceed from step 258 to step 260.

Step 260 may include performing wireless communications, by the WTRU, based on the determinations performed at steps 256 and 258, as described above. Accordingly, step 260 may be carried out in a same or similar manner as step 206 of FIG. 2A. Additionally, step 260 may include performing the wireless communications further based on the power control parameters determined at step 256. For example, the WTRU may perform power scaling on the multiple cells using one or more TPC commands and/or OLPC parameter sets indicated by the separate DCI.

In some embodiments, the WTRU may be configured to determine, at step 204, the target cells prior to receiving a single DCI scheduling multiple cells. The gNB may send an explicit indication or alternatively the WTRU may determine the target cells implicitly from another indication transmitted by the gNB.

In some embodiments, the WTRU may be configured to receive a DCI to determine the target cells. Such DCI may be received separately from the single DCI scheduling the target cells. For example, the DCI indicating the target cells may be received prior to the single DCI scheduling the target cells. The WTRU may use the received information regarding the target cells (number of cells and the cell IDs) to decode the single DCI scheduling the target cells. Alternatively, the DCI indicating the target cells can be received after the single DCI scheduling the target cells. The WTRU may first decode the single DCI and then interpret the decoded bits of the single DCI according to the indicated target cells. Such a DCI may be received as a group common DCI or WTRU-specific DCI.

In some embodiments, the WTRU may be configured to receive a MAC CE indicating the target cells. Such a MAC CE may be received on a previous PDSCH transmission on one of the configured cells. Alternatively, the WTRU may be configured to receive the MAC CE in a pre-determined cell.

In one embodiment, the DCI and/or the MAC CE indicating the target cells may have a bitmap with a size equal to the number of configured cells. A bit location within the bitmap may correspond to the cell ID. For example, the most significant bit (MSB) may correspond to the cell with smallest cell ID and the least significant bit (LSB) may correspond to the cell ID with largest cell ID. Alternatively, the most significant bit (MSB) may correspond to the cell with largest cell ID and the least significant bit (LSB) may correspond to cell ID with smallest cell ID. When a bit is set to “1” (or set to 0), the WTRU may determine that the corresponding cell is among the target cells.

The WTRU may be indicated using radio resource control (RRC) signaling with the target cells. A target cell may be associated with a cell using RRC signaling. When receiving a single DCI scheduling multiple cells on one of the configured cells, the WTRU may determine the target cells using the RRC association between the cell where the single DCI was received and the target cells. For example, the WTRU may be configured with 6 cells: cell1, cell2, cell3, cell4, cell5, and cell6. Cell1 may be associated with cell1, cell2, and cell3 and cell4 may be associated with cell4, cell5, and cell6. When the WTRU receives a single DCI scheduling multiple cells in cell1, the WTRU may determine that the target cells are cell1, cell2, and cell3. When the WTRU receives a single DCI scheduling multiple cells in cell4, the WTRU may determine that the target cells are cell4, cell5, and cell6. In another embodiment, the target cells associated with a cell can be broadcast using the SIB information or RRC configured in case of handover.

The WTRU may be configured to determine the target cells implicitly from another indication received from the gNB. In one embodiment, the WTRU may be configured to determine the target cells based on the acquired bandwidth in unlicensed spectrum. The WTRU may be configured with wideband operation in unlicensed band with a multiple listen before talk (LBT) bandwidth (BW). The WTRU may monitor a gNB indication regarding the acquired LBT BW. Upon determining the acquired LBT BWs, the WTRU may determine that the cells with frequency allocation belonging to one of the acquired LBT BWs will be target cells either for PUSCH or PDSCH transmissions. Alternatively, the WTRU may initiate LBT procedures and acquire a set of LBT BWs. The WTRU may determine that the cells with frequency allocation belonging to one of the acquired LBT BWs will be target cells either for PUSCH or PDSCH transmissions. For example, the WTRU may initiate its own LBT, acquire a set of LBT BWs, and share the channel occupancy time (COT) with the gNB. Such COT can be used for scheduling PUSCH or PDSCH transmission.

In some embodiments, the WTRU may be configured to determine the target cells based on active cells. For example, the WTRU may receive a MAC CE (and/or DCI) activating and/or deactivating a set of configured cells. The WTRU may then exclude the set of deactivated cells from the target cells.

In another embodiment, the WTRU may be configured to update the target cells based on which cell is a primary cell (PCell). For example, the WTRU may determine the target cells associated with a PCell from broadcasted SIB information or RRC configuration for handover. If the WTRU is re-selecting the PCell, the WTRU may update the target cells accordingly.

In some embodiments, the WTRU may be configured to determine the number of scheduled cells based on an indicated value of a counter Downlink Assignment Index (DAI) and/or an indicated value of total DAI in the received DCI (i.e., the received single DCI scheduling multiple cells). In one example, the WTRU may be configured to determine the number of scheduled cells based on the difference between the indicated value of total DAI and the counter DAI. For example, the WTRU may receive a single DCI scheduling multiple cells with a total DAI bitfield indicating a value of N1 and a counter DAI bitfield indicating a value of N2. When N1>N2, the WTRU may determine that the number of scheduled cells with the single DCI is equal to N1-N2. Alternatively, the WTRU may be preconfigured with a table that may have values of numbers of cells and the value of N1-N2 can point to an index in that table. The WTRU may be configured to order the HARQ-ACK feedback bits of the scheduled PDSCHs using the order of the cell index on which PDSCH is scheduled.

At step 204, the WTRU may determine the target cells based on one or more characteristics of the scheduling DCI.

In performing the determining at step 204, the WTRU may be configured to monitor multiple DCI formats to schedule different target cells. Each DCI format can support scheduling different numbers of cells and/or combinations of cells. A DCI format may have fixed size. In one embodiment, a DCI format can be designed in the specification to schedule N cells and the WTRU may further be configured by the gNB to associate such a DCI format with N cells. For example, RRC configuration may associate the DCI format to N cell IDs. A DCI format scheduling N cells can be associated with different combinations of cells and result in having different DCI formats with the same number of scheduled cells (i.e., number of targeted cells). For example, a WTRU may be configured with 6 cells: cell1, cell2, cell3, cell4, cell5, and cell6. As shown in Table 1, a first DCI format (format 2-a) may schedule cell1 and cell2, a second DCI format (format 2-b) may schedule cell3 and cell4, a third DCI format (format 2-c) may schedule cell5 and cell6, and a fourth DCI format (format 6-a) may schedule cell1, cell2, cell3, cell4, cell5, and cell6. Each DCI format associated with a combination of cells (i.e., target cells) can have different bitfields/contents.

TABLE 1
Example of DCI formats associated with a combination of cells

| | Cell1 | Cell2 | Cell3 | Cell4 | Cell5 | Cell6 |
|---|---|---|---|---|---|---|
| DCI format 2-a | Yes | Yes | No | No | No | No |
| DCI format 2-b | No | No | Yes | Yes | No | No |
| DCI format 2-c | No | No | No | No | Yes | Yes |
| DCI format 6-a | Yes | Yes | Yes | Yes | Yes | Yes |

In one embodiment, the WTRU may be triggered to monitor a DCI format associated with a combination of cells (i.e., target cells) based on one or more previously received DCI formats. For example, when the WTRU receives first and second DCI formats within the previous K slots (e.g., K may be configured to the WTRU or fixed in the specification), the WTRU may start monitoring a third DCI format for L slots (e.g., K may be configured to the WTRU or fixed in the specification). In another example related to Table 1, if the WTRU receives DCI formats 2-a, 2-b, and 2-c within the previous K slots, the WTRU may respond by starting to monitor format 6-a for the next L slots.

In some embodiments, the WTRU may be configured to stop monitoring a DCI format upon deactivating a cell that is associated with the DCI format. For example, the WTRU may receive a deactivating indication from the gNB for cell1. The WTRU may respond by stopping monitoring of DCI format 2-a. The WTRU may fallback to monitor a single DCI scheduling a single cell for cell2 (e.g., after a cell associated with the DCI format is deactivated, after or in connection with stopping the monitoring, etc.).

In some embodiments, the WTRU may be configured with a same size for all the DCI formats that will be scheduling multiple cells. The DCI formats that will be scheduling multiple cells may have a format identifier bitfield to indicate which format is the DCI. The WTRU may determine, at step 204, the target cells based on the indicated DCI format in the identifier bitfield. For example, if the WTRU receives identifier bitfield pointing to format 2-c, the WTRU may determine that the target cells are cell5 and cell6 (as in Table 1).

In some embodiments, a WTRU may be configured to determine, at step 204, the target cells based on the RNTI used to scramble the CRC of the scheduling DCI (the single DCI scheduling multiple cells). When the WTRU is configured with a DCI format scheduling multiple cells, the WTRU may be configured to monitor such format and to decode it using multiple RNTIs with each RNTI corresponding to a combination of cells. For example, the WTRU is configured with a DCI with fixed size that can schedule one or multiple cells. When the WTRU attempts to decode the DCI, the WTRU may use a different configured RNTI and, upon successfully decoding the DCI, the used RNTI may indicate to the WTRU the target cells.

A WTRU may be configured with association between RNTI and target cells. Such configuration can be semi-statically configured using RRC signaling. For example, the WTRU may be configured with four cells that can be jointly scheduled using the same DCI. Cell 1 and cell 2 associated with a first RNTI (e.g., X1-RNTI), cell 1 and cell 3 associated with a second RNTI (e.g., X2-RNTI), cell 1 and cell 4 associated with a third RNTI (e.g., X3-RNTI), cell 2 and cell 3 associated with a fourth RNTI (e.g., X4-RNTI), cell 2 and cell 4 associated with a fifth RNTI (e.g., X5-RNTI), cell 3 and cell 4 associated with a sixth RNTI (e.g., X6-RNTI). Upon successfully decoding the DCI with one of the configured RNTI, the WTRU may determine the target cells using this association between RNTI and target cells. More generally, for N cells that can be jointly scheduled using a single DCI, the WTRU may be configured with M number of RNTIs that can scramble the single DCI, where M is less than or equal to Σₖ₌₁^{k=N}(ₖ^{N}). The association between a sub-group of N cells (e.g., target cells) and the M RNTI can be configured semi-statically or fixed in the specification (e.g., in the form of table).

In some embodiments, a WTRU may be configured to associate a group of cells with a search space set. When the WTRU receives a single DCI scheduling multiple cells, the WTRU may determine, at step 204, the target cells based on the associated cells with the search space set on which the single DCI is received. For example, the WTRU may be configured with two search space sets {s1, s2} and 6 cells {cell1, cell2, cell3, cell4, cell5, cell6}. Search space set s1 may be associated with {cell1, cell2, cell3} and search space s2 may be associated with {cell4, cell5, cell6}. When a single DCI scheduling multiple cells is received on s1, the WTRU may determine that the target cells are {cell1, cell2, cell3}. When a single DCI scheduling multiple cells is received on s2, the WTRU may determine that the target cells are {cell4, cell5, cell6}. The search space set RRC configuration may include a group of cells (i.e., target cells) in addition to DCI format. Alternatively, the search space set configuration may include only the target cells.

In some embodiments, the WTRU may be configured to monitor the same DCI format for all possible scheduled cells. Such a DCI may have a fixed size regardless of the number of target cells. Such DCI may contain a target cell's identifier bitfield. The WTRU may determine, at step 204, the target cell(s) to be scheduled based on the target cell's identifier bitfield in the DCI. A value of the target cell's identifier can be mapped to a combination of configured cells. For example, the WTRU may be configured with {cell1, cell2, cell3, cell4, cell5, cell6}. RRC configuration can configure the WTRU to associate a value of a target cell's identifier bitfields to target cells as shown in Table 2:

TABLE 2
Example of target cells identifier
association with target cells

| Target cells | |
|---|---|
| identifier | |
| bitfield | Target cells |
| 00 | cell1, cell2 |
| 01 | cell3, cell4 |
| 10 | cell5, cell6 |
| 11 | cell1, cell2, cell3, cell4, cell5, cell6 |

In some embodiments, the target cell identifier bitfield value may be mapped to different tables depending on the search space set on which the single DCI was received. For example, the WTRU may be configured with two search space sets, each search space set being associated with a different table as shown in Table 3 and Table 4.

TABLE 3
Target cells identifier association with target cells
when single DCI is received in search space set 1

| Target cells | |
|---|---|
| identifier | |
| bitfield | Target cells |
| 00 | cell1, cell2 |
| 01 | cell1, cell2, cell3 |
| 10 | cell1, cell2, cell3, cell4 |
| 11 | cell1, cell2, cell3, cell4, cell5, cell6 |

TABLE 4
target cells identifier association with target cells
when single DCI is received in search space set 2

| Target cells | |
|---|---|
| identifier | |
| bitfield | Target cells |
| 00 | cell1, cell2, cell3 |
| 01 | cell4, cell5, cell6 |
| 10 | cell1, cell2, cell3, cell4 |
| 11 | cell3, cell4, cell5, cell6 |

In some embodiments, the WTRU may be configured to equally split the blind decoding efforts among all the configured “single DCI scheduling multiple cells”. In another embodiment, the WTRU may be configured with different blind decoding efforts for each “single DCI scheduling multiple cells”. For example, the WTRU may support a maximum number of blind decoding attempts of DCIs for all the configured cells. Each DCI scheduling a combination of cells (target cells) may be configured with a different number of DCI blind decoding attempts. In one example embodiment, the number of blind decoding attempts for a single DCI scheduling multiple cells depends on the number of targeted cells for that DCI. For example, a first DCI format can be configured to schedule 2 cells and a second DCI format can be configured to schedule 3 cells. In an example, the number of blind decoding attempts for the first DCI is equal to 2×Nmax/(2+3) and the number of blind decoding attempts for the second DCI is equal to 3×Nmax/(2+3), where Nmax is the maximum number of blind decoding attempts of DCIs for all the configured cells. The number of blind decoding attempts per DCI format is equal to a scaled maximum number of blind decoding attempts of DCIs for all the configured cells. The scaling factor for each DCI format may depend on the number of simultaneously scheduled cells.

At step 204, the WTRU may implement two stage scheduling.

In some embodiments, the WTRU may be configured to receive a first DCI indicating some scheduling information and a subsequent DCI carrying remaining scheduling information. For example, the first DCI can indicate the target cells (i.e., how many cells and which cells will be scheduled) and the second DCI can carry the resource allocation information. The first DCI can indicate the target cells using a bitmap with the size of the configured cells. The most significant bit (MSB) may correspond to the cell with the smallest cell ID and the least significant bit (LSB) may correspond to the cell ID with the largest cell ID. A value of 1 may correspond to a cell being a target cell while 0 value may correspond to a cell not being a target cell. In another embodiment, the first DCI can indicate the target cells by triggering channel state information (CSI) and/or sounding reference signal (SRS) transmission of a subset of the configured cells. The WTRU may determine a cell is a target cell if a CSI or SRS transmission is triggered by the first DCI.

In some embodiments, the WTRU may be configured with two different DCI formats to monitor the two-stage scheduling. A first DCI format for the first DCI with possibly small size, and a second DCI format for the second DCI with possibly bigger size. The WTRU may be configured to monitor the first DCI format and the second DCI format with different aggregation levels. For example, a first DCI format can be configured with low aggregation level and a second DCI format can be configured with high aggregation level. The WTRU may be configured with different search space sets for the first and the second DCI formats. The first search space set may monitor the first DCI format with large periodicity (e.g., WTRU to monitor the first search space set every 5 ms). The second search space set may monitor the second DCI format with small periodicity (e.g., WTRU to monitor the second search space set every 1 ms).

The first and the second DCI may have a different configuration of one or more of the following: DCI format: for example, the first DCI is configured to be received in a first DCI format and the second DCI is configured to be received in a second DCI format; control resource set (CORESET): for example, the first DCI may be configured to be received in a first CORESET and the second DCI may be configured to be received in a CORESET; search space set: for example, the first DCI may be configured to be received in a first search space set and the second DCI may be configured to be received in a second search space set; bandwidth part (BWP): for example, the first DCI may be configured to be received in a first BWP and the second DCI may be configured to be received in a second BWP; cell: for example, the first DCI may be configured to be received in a first cell and the second DCI may be configured to be received in a second cell; and transmission reception point (TRP): for example, the first DCI may be configured to be received in a first TRP and the second DCI may be configured to be received in a second TRP.

In some embodiments, the WTRU may be configured with a validity time for the first DCI. Upon receiving a first DCI carrying some scheduling information, the WTRU may assume that the scheduling information is valid for a configured number of slots (e.g., the number of slots can be configured to the WTRU semi-statically using RRC signaling, dynamically indicated using a bitfield in the first DCI, or alternatively fixed in the specification). For example, the WTRU may receive a first DCI indicating the target cells. The WTRU may assume that the target cells information is valid for 10 ms. The WTRU may be configured to fallback to assume certain scheduling information after the validity time. For example, upon the expiry of the validity time, the WTRU may assume that the target cells are all the configured cells. In another example, upon the expiry of the validity time, the WTRU may assume that the target cell is only the primary cell (PCell) or a pre-configured cell. In another example, upon the expiry of the validity time, the WTRU may assume that the target cells are a set of pre-configured cells.

In some embodiments, the WTRU may be configured to report positive acknowledgment or negative acknowledgment (ACK/NACK) for the reception of the first DCI. The WTRU may be configured with a physical uplink control channel (PUCCH) resource to report the ACK/NACK of the reception of the first DCI. The PUCCH resource can be configured semi-statically using RRC signaling or dynamically indicated in the first DCI using a PUCCH resource indicator (PRI). In some embodiments, the WTRU may be configured to report ACK/NACK for the reception of the first DCI along with the hybrid automatic repeat request acknowledgement (HARQ-ACK) report of the scheduled PDSCHs transmission scheduled by both the first DCI and the second DCI. For example, the first DCI may indicate target cells and the second DCI may schedule the PDSCHs on the target cells. The WTRU may report the HARQ-ACK feedback for the scheduled PDSCHs and the ACK/NACK of the first DCI in the same PUCCH resource or PUSCH resource.

In some embodiments, the WTRU may be configured to receive a first DCI on one or more control channels and a second DCI on one or more data channels. The second DCI may be multiplexed with a PDSCH transmission on one of the scheduled cells. For example, the WTRU may be indicated by a first DCI of the target cells and schedule PDSCH transmission on one of the cells (e.g., scheduling PDSCH on PCell). The scheduled PDSCH on PCell may be multiplexed with a second DCI to carry additional scheduling information regarding the target cells.

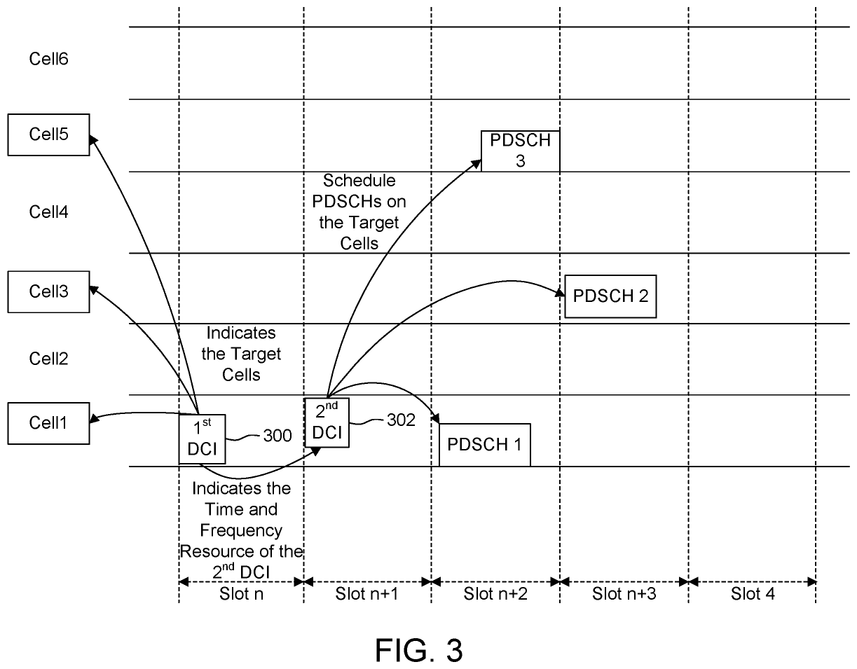

In some embodiments, the first DCI may indicate some scheduling information for multiple cells and may schedule a transmission occasion, frequency domain occasion, and/or transmission parameters for a second DCI that may carry the remaining scheduling information for the multiple cells. For example, and as shown in FIG. 3, the first DCI 300 may indicate the target cells and indicate the slot location where the WTRU should expect the second DCI 302. The slot location may be an offset relative to the slot where the first DCI 300 is received. In another example, the first DCI may indicate the target cells and indicate the search space set ID where the WTRU should expect the second DCI. In another example, the first DCI may indicate the target cells and indicate the control channel element (CCE) where the WTRU should expect the second DCI.

In some embodiments, the WTRU may be configured to receive the first and the second DCI within the same search space set or within the same search space set and aggregation level (AL). The WTRU may first try to detect the first DCI and, in response to successfully decoding the first DCI, try to detect the second DCI. For example, within the same AL, some CCEs may be used for the first DCI and the remaining CCEs may be used for the second DCI. The WTRU may blindly decode only the first CCEs and, in response to detecting the first DCI, decode the remaining CCEs.

The WTRU may be configured to receive a MAC CE indicating the set of cells that will be scheduled for next set of slots (i.e., target cells for the next set of slots) and the MAC CE may be followed by a single DCI scheduling multiple cells. Part of the scheduling information may be carried by the MAC CE and other scheduling information may be carried by the single DCI. Such a MAC CE can be received by the WTRU on a previous PDSCH scheduled on one of the configured cells and can indicate the scheduled cells in one of two ways: Bit map indicating which cell is scheduled and/or to which the grant applies. For example, RRC may configure which subset of cells can be scheduled by a MAC CE, then the MAC CE may indicate (1 or 0) which of these cells is scheduled. Alternatively, it can be all configured cells. The WTRU may omit deactivated cells; and cell indices of scheduled cells concatenated.

In some embodiments, the WTRU may activate a cell upon the reception of a MAC CE that indicates a cell as scheduled. For example, the WTRU may be configured with a cell x and the cell x may be deactivated. When a MAC CE indicates a cell x as a target cell, the WTRU may activate the cell.

In some embodiments, the MAC CE may have two or more formats and the format may be indicated by the gNB in the MAC CE header. For example, a short format may be used where the WTRU assumes the number of scheduled cells is less than a configured number (e.g., 8 cells). The short format may just indicate a cell index instead of a bitmap with a size of the configured cells. The short format may be fixed in size. In another example, a long format may be used where the WTRU assumes the number of scheduled cells is greater than a first configured number and less than a second configured number. A bitmap may be used to indicate which cells are scheduled. The long format may be variable in size depending on the number of scheduled cells indicated.

In some embodiments, the WTRU, in response to receiving a PDSCH retransmission that contains the multi-cell scheduling MAC CE, may discard the grants or assignments, assuming they are no longer valid. In another embodiment, the WTRU may assume the grants/or assignments are valid, starting at an offset from the MAC CE reception time or from the time the HARQ-ACK is transmitted for the transport block (TB) that has the MAC CE.

In some embodiments, the WTRU may be configured to receive a MAC CE that contains one or more of the following: time shift until the start of the grant for each cell or all cells; BWP associated with the scheduled grant, possibly per cell; HARQ process ID (PID) per scheduled cell; other HARQ information (RV, new data indicator (NDI), transport block size (TBS), modulation and coding scheme (MCS)); whether the grant is for supplementary uplink (SUL) or normal uplink (NUL); a coreset, transmission configuration indicator (TCI) state, or search space to monitor in the scheduled cell; logical Channel (LCH) in MAC subheader used to identify MAC CE for scheduling multiple cells.

In some embodiments, the WTRU may assume that the grant or DL assignment starts at least X ms after the end of the PDSCH that contains the MAC CE.

At step 206, the WTRU may determine transmission parameters of the scheduled transmissions on the determined target cells.

In some embodiments, the WTRU may be configured to use the same transmission parameters for each cell transmission among the scheduled cells. For example, the single DCI scheduling multiple cells can have a single time domain resource allocation (TDRA) bitfield and the WTRU may assume the same TDRA value for all scheduled transmissions. In another embodiment, the scheduled transmissions on different target cells may have different transmission parameters. The single DCI scheduling multiple cells can have a single bitfield per transmission parameter for all the scheduled cells but pointing to a different value for each cell. For example, different Modulation and Coding Scheme tables can be configured per cell. The WTRU may use the MCS bitfield value in the single DCI scheduling multiple cells to determine the MCS value for each cell based on its MCS table. In another embodiment, the WTRU may be configured to use the same transmission parameters for a subset of transmission parameters and different transmission parameters for another subset of transmission parameters.

In some embodiments, when determining the transmission parameters for a scheduled cell, the WTRU may be configured to ignore a bitfield corresponding to a certain transmission parameter in the single DCI scheduling multiple cells if a scheduled cell is not configured with that transmission parameter. For example, for a single DCI scheduling two cells, one cell may belong to unlicensed band and another cell may belong to licensed band. The single DCI may contain a bitfield corresponding to channel access priority type. The WTRU may use the channel access priority type bitfield for the unlicensed cell when the unlicensed cell is within the target cells and the WTRU may ignore the channel access priority type bitfield if the unlicensed cell is not within the target cells.

In some embodiments, the WTRU may be configured with a single DCI scheduling multiple cells that does not include all the transmission parameters for all the cells. The WTRU may assume a semi-static configuration for a certain transmission parameter if the bitfield does not exist. For example, a cell may support transmissions with different priorities but the single DCI scheduling multiple cells may not include a priority indication. In such a case, the WTRU may assume the transmission scheduled by the single DCI scheduling multiple cells is a low priority transmission.

In some embodiments, the WTRU may be configured to determine the set of bitfields present in the DCI scheduling multiple cells based on identified target cells. The set of bitfields may be defined as a group of bitfields to be present in the DCI. The DCI can be scheduling uplink transmissions (e.g., multiple PUSCHs) or downlink transmissions (e.g., multiple PDSCHs) and the target cells can be determined using the methods described previously. For example, Table 5 shows two different sets of bitfields. The WTRU can be configured with an association between a set of bitfields and target cells. Each bitfield in the set of bitfields can be configured to be either a common indication (e.g., the same value applies to the target cells), a joint indication (e.g., the same bitfield value but can be pointing to different RRC configured values), or a separate indication (e.g., a separate bitfield) for transmission parameters. Such configuration can be provided to the WTRU using RRC signaling. For example, a WTRU can be scheduled by a single DCI to schedule four possible cells (i.e., cell 1, cell2, cell3 and cell4). The target cells Cell1 and Cell2 can be associated with S1 (i.e., a first set of bitfields) and target cells Cell 3 and Cell 4 can be associated with S2 (i.e., a second set of bitfields). Upon determining that the target cells are cell 3 and cell 4, the WTRU may assume that the second set of bitfields (S2) is present in the DCI. As shown in Table 5, the set of bitfields S2 has joint indication of frequency domain resource allocation (FDRA) for cell 3 and cell 4 (i.e., same codepoint in the bitfield but different frequency domain allocation) and the common time domain resource allocation (TDRA) (i.e., same codepoint in the bitfield and the same time domain allocation).

| | Set of bitfields S1 | Set of bitfields S2 |
|---|---|---|
| First bitfield | FDRA for cell 1 | FDRA joint indication |
| | | for both cell 3 and cell 4 |
| Second | FDRA for cell 2 | TDRA common indication |
| bitfield | | for both cell 3 and cell 4 |
| Third bitfield | TDRA for cell 1 | HARQ PID joint indication |
| | | for cell 1 and cell 2 |
| Fourth bitfield | TDRA for cell 2 | MCS common indication |
| | | for cell 1 and cell 2 |
| Fifth bitfield | HARQ PID joint | |
| | indication for cell | |
| | 1 and cell 2 | |
| Sixth bitfield | MCS joint indication | |
| | for cell 1 and cell2 | |

In some embodiments, the WTRU can be configured with a single DCI scheduling multiple cells to have one set of bitfields always present regardless of the determined target cells and a second set of bitfields that depends on the determined target cells. The always present set of bitfields can carry scheduling information which does not depend on the target cells. For example, the always present set of bitfields may include a TPC command for PUCCH bitfield, PUCCH resource indicator bitfield, and PDSCH-to-HARQ feedback timing indicator. When the WTRU identifies the target cells, the WTRU may assume that the DCI bitfields include the always present set of bitfields and the set of bitfields that are dependent on the target cells. For example, when the WTRU determines target cells (e.g., cell 3 and cell 4 in the example presented above), the WTRU may assume the DCI includes the always present set of bitfields and the set of bitfields S2.

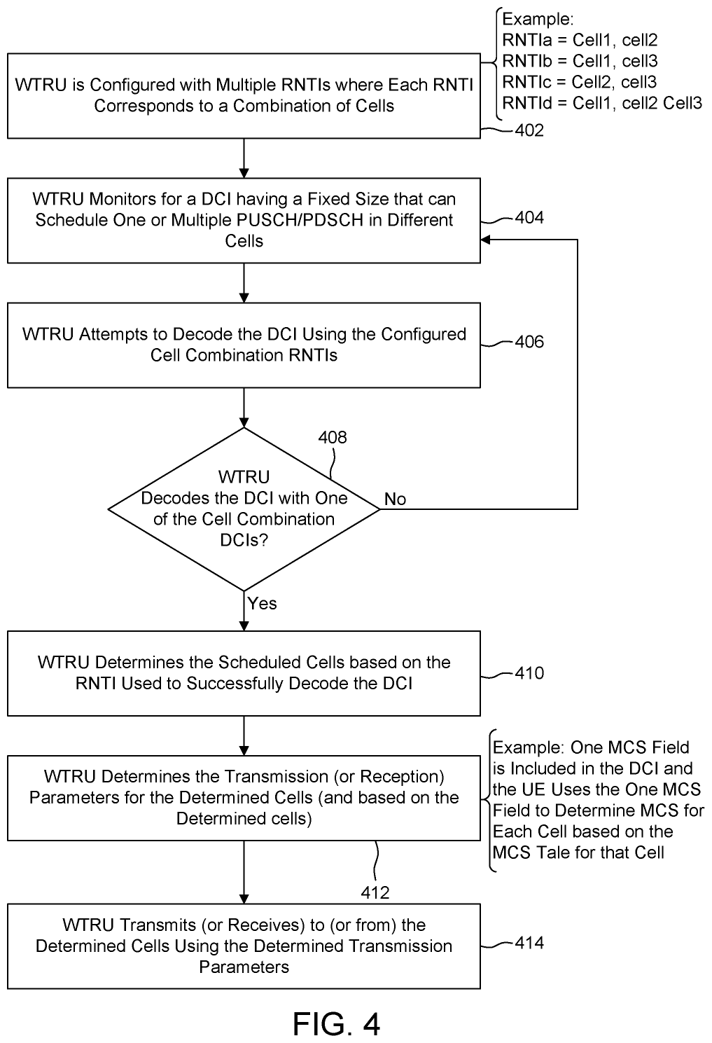

Referring to FIG. 4, an example implementation is presented as a method 400 in which the WTRU is configured, at step 402, with multiple RNTIs, where each RNTI is associated with a combination of cells (i.e., target cells). The WTRU may monitor, at step 404, for a DCI with a fixed size that can schedule one or more PUSCH/PDSCH in different cells and attempt to decode, at step 406, the DCI candidates using the configured cell combination RNTIs. In response to a successful decoding at step 408, the WTRU may determine, at step 410, the scheduled cells/target cells based on the RNTI used to successfully decode the DCI. The WTRU may then determine, at step 412, the transmission (or reception) parameters for the determined cells based on the determined cells. For example, the WTRU may use the set of bitfields associated with the target cells described above. Finally, the WTRU may, at step 414, exchange information (e.g., transmit (or receive) to (or from) the determined cells) using the determined transmission parameters.

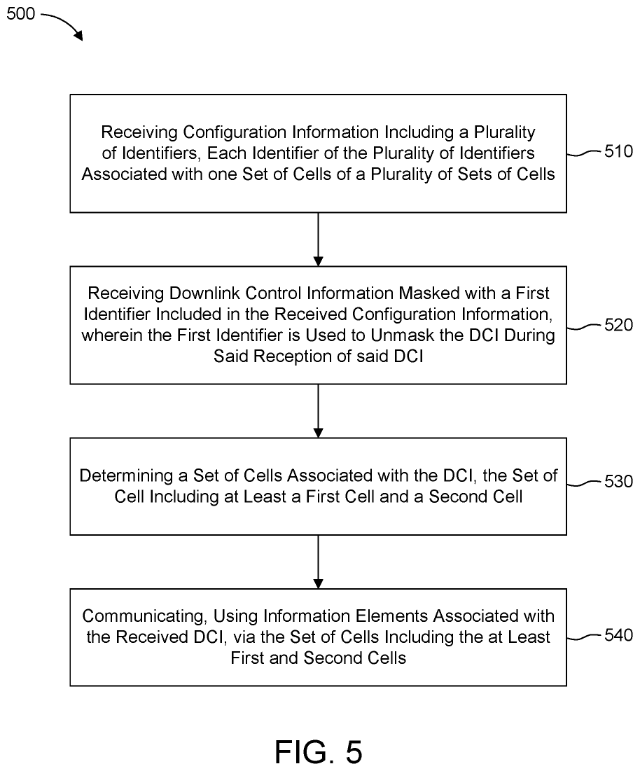

Referring to FIG. 5, an example of a flow diagram illustrating a method 500 implemented in a WTRU for enabling single downlink control information scheduling of multiple cells is depicted. At step 510, the WTRU may be configured to receive configuration information including a plurality of identifiers, each identifier of the plurality of identifiers being associated with one set of cells of a plurality of sets of cells. At step 520, the WTRU may be configured to receive downlink control information (DCI) masked with a first identifier included in the received configuration information, wherein the first identifier is used to unmask the DCI during said reception of said DCI. At step 530, the WTRU may be configured to determine a set of cells associated with the DCI, the set of cells including at least a first cell and a second cell; and at step 540, the WTRU may be configured to communicate, using information elements associated with the received DCI, via the set of cells including the at least first and second cells.

In some embodiments, the WTRU may perform configured grants transmission at step 206. For example, the WTRU may be configured with a DCI format that can activate/deactivate one or more configured grants/DL semi-persistent scheduling (SPS) transmission on a group of cells. The WTRU may be configured using RRC configuration with multiple configured grant(s)/DL SPS(s) on multiple cells and such a DCI may activate/deactivate one or more of the configured grants/DL SPS(s) on the target cells. The WTRU may be configured with multiple RNTIs to use for monitoring the single DCI triggering multiple configured grants/DL SPS on different cells. In one embodiment, each RNTI can be associated with a combination of cells. In response to receiving a single DCI scheduling multiple cells scrambled with a specific RNTI, the WTRU may trigger all the configured grants/DL SPS transmissions on the target cells. In another embodiment, each RNTI may be associated with a set of configured grants/DL SPS on one or more cells. In response to receiving a single DCI scheduling multiple cells scrambled with a specific RNTI, the WTRU may trigger the transmission of only configured grants/DL SPS resources associated with the RNTI.

The WTRU may be configured with an RNTI associated with a configured grant/DL SPS as part of the RRC configuration of the configured grant/DL SPS. Alternatively, the WTRU may determine the radio network temporary identifier (RNTI) associated with a configured grant/DL SPS resource autonomously using a formula. For example, the WTRU may use the configured grant/DL SPS resource ID and the cell ID to determine the RNTI associated with the configured grant/DL SPS. One example formula may be:

$$RNTI = {RNTI}_{0} + ⌊ \frac{resource ID}{{M}_{1}} ⌋ + ⌊ \frac{cell ID}{{M}_{2}} ⌋ ,$$

where RNT10, M1 and M2 may be separately configured or fixed in the specification.

In some embodiments, after determining the target cells with which a configured grant/DL SPS the received single DCI is associated, the WTRU may respond by determining whether to activate or deactivate a configured grant/DL SPS within a cell based on a bitfield in the DCI. For example, the WTRU may determine if one or more pre-defined DCI bitfields is set to some special values to determine which one of the DL SPS/configured grants is to be triggered or released.

In some embodiments, the WTRU may perform transmission of both configured and dynamic grants at step 206. For example, the WTRU may be configured with a DCI format that can activate one or more configured grants/DL SPSs transmission on a subset of cells and schedule a dynamic grant on another subset of cells. The WTRU may be configured using RRC configuration with multiple configured grant(s)/DL SPS(s) on multiple cells. Such a DCI may activate one or more of the configured grants/DL SPS(s) on the cells within the target cells and dynamically schedule grants on some cells within the target cells. The WTRU may be configured with multiple RNTIs to use for monitoring the single DCI triggering configured grants/DL SPSs and dynamically scheduling on multiple cells. In one embodiment, each RNTI can be associated with a configured grant/DL SPS on a first subset of cells and dynamic grants on a second subset of cells. In response to receiving a single DCI scheduling multiple cells scrambled with a specific RNTI, the WTRU may enable/disable the configured grants/DL SPS transmissions on the first subset of cells and transmit one or more dynamically scheduled grants on the second subset of cells (target cells=first subset+second subset) associated with the used RNTI. The WTRU may determine whether to activate or deactivate a configured grant/DL SPS within a cell based on a bitfield in the DCI. For example, the WTRU may determine if a pre-defined DCI bitfields is set to some special values to determine which one of the DL SPS/configured grants is to be triggered or released. The WTRU may be configured to ignore the scheduling information indicated in the single DCI scheduling multiple cells for the configured grants/DL SPS resource. The WTRU may use the scheduling information indicated in the single DCI scheduling multiple cells for dynamic grants.

In some embodiments, the WTRU may be configured to receive a separate DCI from the single DCI scheduling multiple cells. This separate DCI may indicate the power control parameters for each cell. The separate DCI may indicate for each cell one or more of the following: transmit power control (TPC) command. For example, the separate DCI may contain 2 bits per cell to indicate the TPC command value; open loop power control (OLPC) parameter set. For example, the separate DCI may contain N bits per cell to indicate the open loop power control parameter set indication. Alternatively, the WTRU may be configured with a single bitfield per cell to indicate the OLPC parameter set.

In some implementations, the WTRU may be configured to determine whether a cell is to be scheduled or not (using the single DCI) based on the indicated power control parameters for that cell. For example, a zero transmit power indicated for a cell can be interpreted by the WTRU as no transmission is scheduled for that cell. The WTRU may then decode the single DCI scheduling multiple cells accordingly.

In some solutions, when scaling the power among the scheduled cells for PUSCH transmissions, the WTRU may be configured to prioritize between the scheduled cells. For example, when the WTRU is scheduled with multiple PUSCH transmissions on different cells, the WTRU may allocate the available transmit power among the scheduled cells using some priority rule. The WTRU may be configured to prioritize, during the power scaling procedure, between the scheduled cells based on one or more of the following: the cell index of the scheduled cell, for example, the WTRU may allocate a larger scaling factor (power scaling factor) to the cell with index equal to 0. The WTRU may be configured to calculate the power scaling factor for each cell based on a formula, and the formula can take in consideration the cell index; the number of PRBs allocated for PUSCH transmission within the cell, for example, the WTRU may be configured to allocate a larger scaling factor to a cell with a larger number of scheduled PRBs for the PUSCH transmission; the number of symbols allocated for PUSCH transmission within the cell, for example, the WTRU may be configured to allocate a larger scaling factor to a cell with a larger number of scheduled symbols for the PUSCH transmission; subcarrier spacing of the scheduled cell: the WTRU may be configured to prioritize/allocate a larger scaling factor to the cell with larger subcarrier spacing, or Alternatively, the WTRU may be configured to prioritize/allocate a larger scaling factor to the cell with smaller subcarrier spacing; frequency location of the scheduled cell: the WTRU may be configured to prioritize the power allocation to a cell based on the frequency location of the scheduled cell, for example, the WTRU may be configured to allocate higher power to a cell belonging to higher frequency (e.g., due to high path loss channel).

In some embodiments, the WTRU may be configured with CSI-RS and/or SRS on multiple cells and a subset of CSI-RS/SRS can be triggered jointly for reception/transmission on different cells using a single DCI. The WTRU may be configured with a mapping between CSI-RS/SRS resources on a subset of cells and a DCI format(s). Such a DCI format may trigger the transmission/reception of CSI-RS/SRS on the pre-configured subset of cells. In another solution, the WTRU may be configured with a bitfield in the DCI that can indicate the subset of cells on which CSI-RS/SRS resources are triggered. For example, a value of such a bitfield in the DCI can be mapped to a group of CSI/SRS resources on multiple cells. In another embodiment, the search space set and/or CORESET on which the DCI is received can be used as an indication for the set of CSI/SRS resources to be triggered. For example, a search space set can be associated with a group of cells. Upon receiving a DCI on a search space set triggering CSI-RS reception, the WTRU may determine the set of cells on which the CSI RS will be transmitted using a configured association between a search space set and a group of cells. In another example, a bandwidth part (BWP) may be associated with a group of cells. Upon receiving a DCI on a BWP triggering CSI-RS reception on a search space set, the WTRU may respond by determining a set of cells on which the CSI RS will be transmitted using the configured association between the BWP and the group of cells.

In some embodiments, the DCI scheduling multiple cells can have a single bit that triggers the CSI-RS reception/SRS transmission. Based on the methods described above, the WTRU may determine the set of cells to have CSI reception/SRS transmission and the single bit may jointly trigger the reception/transmission of CSI-RS/SRS on the target cells. In another implementation, the DCI scheduling multiple cells may have a bitmap that may enable/disable the CSI-RS reception/SRS transmission on the target cells. For example, in case of semi-persistent CSI scheduling, a value of “one” may enable the CSI-RS reception and a value of “zero” may disable the CSI-RS reception. The WTRU may be configured to determine the target cells on which a semi-static CSI-RS is to be enabled/disabled based on the methods described above. Using the bitmap included in the DCI, the WTRU may further determine whether CSI is enabled or disabled.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, MME, EPC, AMF, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

The WTRU may be used in conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

### REFERENCES

The following references may have been referred to herein above and are incorporated in full herein by reference.
[1] RP-213577, “New WID on Multi-carrier enhancements”

The invention claimed is:

1-18. (canceled)

19. A method, implemented in a wireless transmit/receive unit (WTRU) comprising:
receiving a first message comprising first configuration information indicating a fixed size format of a downlink control information (DCI) and a plurality of cell identifiers, wherein each cell identifier of the plurality of cell identifiers is associated with a combination of cells of a plurality of cells, and comprising second configuration information indicating sounding reference signal (SRS) resources associated with the plurality of cells for transmitting SRS to a subset of cells of the plurality of cells;
receiving a DCI having the fixed size format, comprising first information indicating a cell identifier of the plurality of cell identifiers and comprising second information indicating a subset of cells of the plurality of cells associated with the SRS resources;
determining, based on the received DCI, a combination of cells of the plurality of cells, associated with the cell identifier; and
transmitting communication via the combination of cells and transmitting SRS to the subset of cells.

20. The method of claim 19, wherein the plurality of cell identifiers is indicated in a first bit field of fixed size of the DCI.

21. The method of claim 19 comprising monitoring one or more DCIs having the configured fixed size format.

22. The method of claim 19, wherein the first configuration information indicates receiving one or more DCIs having respectively the same fixed size format for scheduling transmission to one or more cells.

23. The method of claim 19, wherein the subset of cells associated with the SRS resources is indicated in a second bit field of the DCI.

24. The method of claim 23, wherein a value of the second bit field indicates a subset of SRS resources of the SRS resources associated with the subset of cells.

25. A wireless transmit/receive unit (WTRU) comprising a processor, a transmitter, a receiver and memory, configured to:
receive a first message comprising first configuration information indicating a fixed size format of a downlink control information (DCI) and a plurality of cell identifiers, wherein each cell identifier of the plurality of cell identifiers is associated with a combination of cells of a plurality of cells, and comprising second configuration information indicating sounding reference signal (SRS) resources associated with the plurality of cells for transmitting SRS to a subset of cells of the plurality of cells;
receive a DCI having the fixed size format, comprising first information indicating a cell identifier of the plurality of cell identifiers, and comprising second information indicating a subset of cells of the plurality of cells associated with the SRS resources;
determine, based on the received DCI, a combination of cells of the plurality of cells, associated with the cell identifier; and
transmit communication via the combination of cells and transmitting SRS to the subset of cells.

26. The WTRU of claim 25, wherein the plurality of cell identifiers is indicated in a first bit field of fixed size of the DCI.

27. The WTRU of claim 25 comprising monitoring one or more DCIs having the configured fixed size format.

28. The WTRU of claim 25, wherein the first configuration information indicates receiving one or more DCIs having respectively the same fixed size format for scheduling transmission to one or more cells.

29. The WTRU of claim 25, wherein the subset of cells associated with the SRS resources is indicated in a second bit field of the DCI.

30. The WTRU of claim 29, wherein a value of the second bit field indicates a subset of SRS resources of the SRS resources associated with the subset of cells.
